(19) United States
(12) Patent Application Publication
(10) Pub. No.: US 2015/0260605 A1
(43) Pub. Date: Sep. 17, 2015

(54) REFRACTIVE-INDEX DISTRIBUTION MEASURING METHOD, REFRACTIVE-INDEX DISTRIBUTION MEASURING APPARATUS, METHOD OF MANUFACTURING OPTICAL ELEMENT, AND NON-TRANSITORY COMPUTER-READABLE STORAGE MEDIUM

(71) Applicant: CANON KABUSHIKI KAISHA, Tokyo (JP)

(72) Inventor: Seima Kato, Utsunomiya-shi (JP)

(21) Appl. No.: 14/657,587

(22) Filed: Mar. 13, 2015

(30) Foreign Application Priority Data
Mar. 14, 2014 (JP) 2014-051270

(51) Int. Cl. G01M 11/02

(52) U.S. Cl. CPC G01M 11/0228

(57) ABSTRACT

A refractive-index distribution measuring method includes the steps of measuring a transmitted wavefront of an object, determining a first refractive index distribution of the object based on a measurement result of the transmitted wavefront, determining a third refractive index distribution in a transmission direction of light of the transmitted wavefront based on information related to a second refractive index distribution of the object, and calculating a three-dimensional refractive index distribution of the object based on the first refractive index distribution and the third refractive index distribution.

### BACKGROUND OF THE INVENTION

1. Field of the Invention

The present invention relates to a method of measuring a refractive index distribution.

2. Description of the Related Art

Japanese Patent Laid-open No. 2011-247692 discloses a method of measuring a transmitted wavefront in a state where an object is immersed in each of two types of media that have different refractive indices from that of the object and calculating a refractive-index distribution projection value of the object. Furthermore, Japanese Patent Laid-open No. 2011-247692 discloses a method of calculating a three-dimensional refractive index distribution by using the measured refractive-index distribution projection value while the object is inclined. According to the measuring method disclosed in Japanese Patent Laid-open No. 2011-247692, the three-dimensional refractive index distribution of the object can be measured without using a medium which has substantially the same refractive index as that of the object even when the object has a high refractive index.

However, in the method disclosed in Japanese Patent Laid-open No. 2011-247692, it is assumed that the light transmits through the object and therefore a measurable direction for an object which has an edge portion such as a lens is limited. The three-dimensional refractive index distribution of the object cannot be accurately measured only with a transmitted wavefront obtained in the limited direction.

### SUMMARY OF THE INVENTION

The present invention provides a refractive-index distribution measuring method, a refractive-index distribution measuring apparatus, and a non-transitory computer-readable storage medium that are capable of measuring a three-dimensional refractive index distribution of an object with high accuracy even when the object has a high refractive index. The present invention also provides a method of manufacturing an optical element that is capable of mass-producing the optical element made of a high refractive-index glass material by mold forming with high accuracy.

A refractive-index distribution measuring method as one aspect of the present invention includes the steps of measuring a transmitted wavefront of an object, determining a first refractive index distribution of the object based on a measurement result of the transmitted wavefront, determining a third refractive index distribution in a transmission direction of light of the transmitted wavefront based on information related to a second refractive index distribution of the object, and calculating a three-dimensional refractive index distribution of the object based on the first refractive index distribution and the third refractive index distribution.

A refractive-index distribution measuring apparatus as another aspect of the present invention includes a measuring unit configured to measure a transmitted wavefront of an object, and a processing unit configured to calculate a three-dimensional refractive index distribution of the object, and the processing unit is configured to determine a first refractive index distribution of the object based on a measurement result of the transmitted wavefront by the measuring unit, determining a third refractive index distribution in a transmission direction of light of the transmitted wavefront based on information related to a second refractive index distribution of the object, and calculating the three-dimensional refractive index distribution of the object based on the first refractive index distribution and the third refractive index distribution.

A method of manufacturing an optical element as another aspect of the present invention includes the steps of molding the optical element and measuring a refractive index distribution of the optical element as the object by using the refractive-index distribution measuring method to evaluate the optical element.

A non-transitory computer-readable storage medium as another aspect of the present invention stores a program causing a computer to execute a process including the steps of measuring a transmitted wavefront of an object, determining a first refractive index distribution of the object based on a measurement result of the transmitted wavefront, determining a third refractive index distribution in a transmission direction of light of the transmitted wavefront based on information related to a second refractive index distribution of the object, and calculating a three-dimensional refractive index distribution of the object based on the first refractive index distribution and the third refractive index distribution.

Further features and aspects of the present invention will become apparent from the following description of exemplary embodiments with reference to the attached drawings.

### BRIEF DESCRIPTION OF THE DRAWINGS

FIG. 1 is a flowchart of illustrating a refractive-index distribution measuring method in Embodiment 1.

FIG. 2 is a configuration diagram of a refractive-index distribution measuring apparatus (apparatus that measures a refractive-index distribution projection value in a radial direction of an object) in Embodiment 1.

FIGS. 3A and 3B are diagrams of illustrating an optical path to the object in the refractive-index distribution measuring apparatus in Embodiment 1.

FIGS. 4A to 4D are configuration diagrams of the refractive-index distribution measuring apparatus (apparatus that measures a refractive index distribution on a slice surface) in Embodiment 1.

FIG. 5 is a diagram of illustrating the optical path to the object in the refractive-index distribution measuring apparatus in Embodiment 1.

FIG. 6 is a configuration diagram of a refractive-index distribution measuring apparatus (apparatus that measures a refractive-index distribution projection value in a radial direction of an object) in Embodiment 2.

FIG. 7 is a schematic diagram of a Shack-Hartmann sensor in Embodiment 2.

FIG. 8 is a flowchart of illustrating a refractive-index distribution measuring method in Embodiment 2.

FIG. 9 is a flowchart of illustrating a refractive-index distribution measuring method in Embodiment 3.

FIG. 10 is a flowchart of illustrating a method of manufacturing an optical element in each embodiment.

### DESCRIPTION OF THE EMBODIMENTS

Exemplary embodiments of the present invention will be described below with reference to the accompanied drawings.

### Embodiment 1

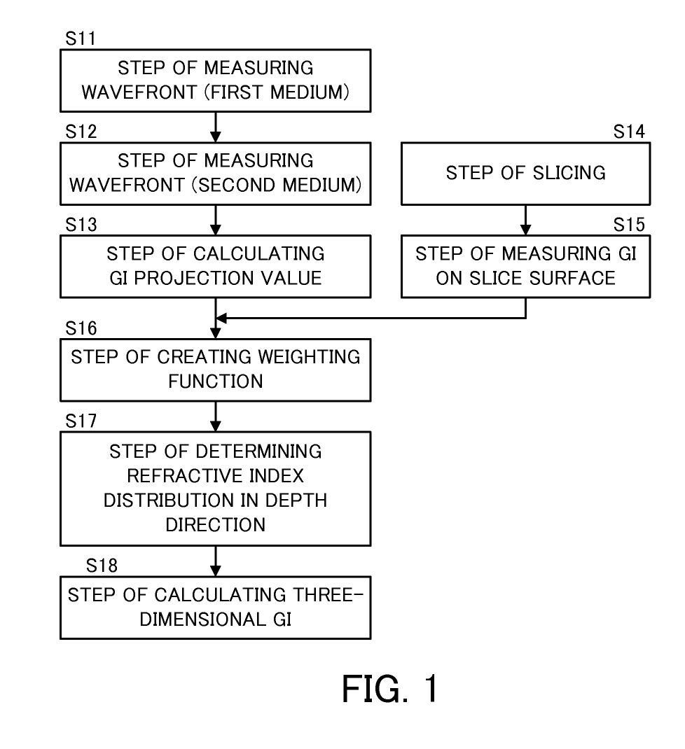

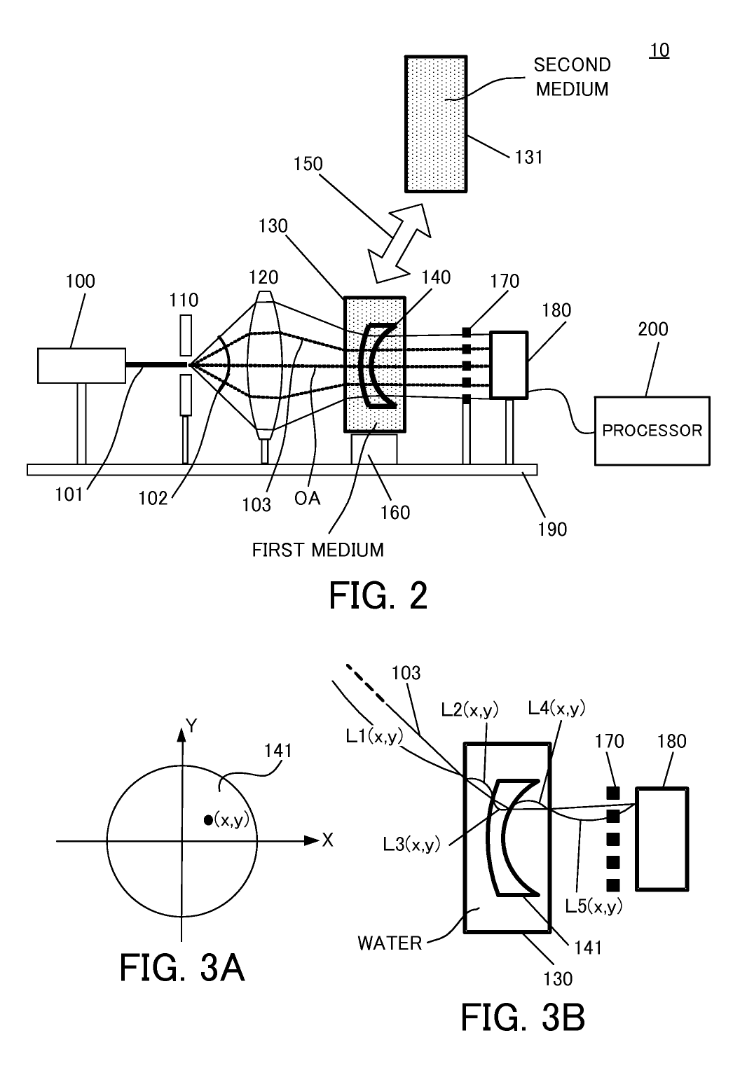

First of all, referring to FIG. 1, a method of measuring (method of calculating) a refractive index distribution (GI) in Embodiment 1 of the present invention will be described. FIG. 1 is a flowchart of illustrating a refractive-index distribution measuring method in this embodiment. Each step in FIG. 1 is performed based on an instruction (command) of a processor 200 illustrated in FIG. 2 described below.

The procedure illustrated in FIG. 1 can be roughly classified into three steps. A first step includes steps S11 to S13 at which an object is immersed in two types of media to calculate a refractive-index distribution projection value in a radial direction of the object based on each of measured values of transmitted wavefronts. A second step includes steps S14 and S15 at which the object is fabricated to be a slice shape to calculate a refractive index distribution on a slice surface. In each embodiment, the refractive index distribution on the slice surface is referred to as prior information. A third step includes steps S16 to S18 at which the refractive-index distribution projection value in the radial direction and the refractive index distribution on the slice surface are combined (synthesized) to calculate a three-dimensional refractive index distribution. Hereinafter, each step will be described in detail.

FIG. 2 is a configuration diagram of a refractive-index distribution measuring apparatus 10 in this embodiment, and the refractive-index distribution measuring apparatus 10 performs steps S11 to S13 in FIG. 1 to calculate the refractive-index distribution projection value in the radial direction. The refractive-index distribution measuring apparatus 10 measures a transmitted wavefront of an object 140 (object being tested) while light emitted from a light source 100 enters the object 140 in a state where the object 140 is immersed in each of two types of media (for example, water and oil) that have refractive indices different from that of object 140. Then, the refractive-index distribution measuring apparatus 10 calculates a refractive index distribution (refractive-index distribution projection value in the radial direction) of the object 140 by using the processor 200 (processing unit) as a computer.

In this embodiment, A Talbot interferometer is used as a measuring unit that measures the transmitted wavefront of the object 140. The object 140 is an optical element such as a lens. A tank 130 is filled with a first medium (for example, water). A tank 131 is filled with a second medium (for example, oil). The tanks 130 and 131 are interchangeable by using a tank interchange mechanism 150. A refractive index of the first medium (water) or the second medium (oil) is less than that of the objet 140 by 0.01 or more. The refractive index of the second medium (oil) is different from that of the first medium (water) by 0.01 or more.

The light source 100 uses a laser light source such as a He—Ne laser. A laser beam 101 emitted from the light source 100 along an optical axis OA is diffracted when passing through a pinhole 110 (optical member). The diffracted light (reference light 102) that is diffracted by the pinhole 110 is changed to convergent light 103 by a collimater lens 120 (CL). The pinhole 110 and the collimater lens 120 are optical members that are capable of generating the convergent light 103 based on the light (laser beam) emitted from the light source 100. The convergent light 103 transmits through the water (first medium) in the tank 130 and the object 140. In this embodiment, the object 140 is a lens rotationally symmetric around an axis. A diameter φ of the pinhole 110 is small enough to treat the diffracted light (reference light 102) as an ideal spherical wave, and is designed to satisfy the following expression (1) by using a numerical aperture NAO at an object side and a wavelength λ of the light source 100.

$$ϕ \approx \frac{λ}{N A O} \qquad ( 1 )$$

The laser beam (convergent light 103) transmitted through the object 140 and the water (first medium) in the tank 130 passes through an orthogonal diffraction grating (diffraction grating 170) as a two-dimensional diffraction grating, and is imaged (measured) by a CCD (detector 180). The detector 180 is provided on an anti-vibration table 190. When the numerical aperture NA of the object 140 at the image side is small and a distance Z between the diffraction grating 170 and the detector 180 satisfies a Talbot condition represented by the following expression (2), a spurious resolution (Talbot image) of the diffraction grating 170 is obtained as an interference pattern on the detector 180.

$$\frac{{Z}_{0} Z}{{Z}_{0} - Z} = \frac{{md}^{ 2}}{λ} \qquad ( 2 )$$

In expression (2), symbol Z denotes a distance between the diffraction grating 170 and the detector 180, which is called a Talbot distance. Symbol m denotes an integer other than zero, and symbol d denotes a grating pitch of the diffraction grating 170. Symbol Z₀ denotes a distance from the diffraction grating 170 to an image plane of the object 140. For example, when the light emitted from the object 140 is parallel light, the distance Z₀ is infinity. The grating pitch d of the diffraction grating 170 is determined depending on an amount of aberration of the object 140.

The object 140 is relatively movable in an optical axis direction and in a direction perpendicular to the optical axis by using a parallel eccentric mechanism 160. The collimater lens 120, the diffraction grating 170, and the detector 180 are relatively movable on a rail (not illustrated) installed to be parallel to the optical axis.

At steps S11 and S12 in FIG. 1, the processor 200 measures the transmitted wavefront of the object 140 by using the measuring unit (the diffraction grating 170 and the detector 180) while the object 140 is immersed in each medium (each of the first medium and the second medium). Specifically, first at step S11, the measuring unit measures the transmitted wavefront (first transmitted wavefront) of the object 140 while the reference light 102 enters the object 140 in the first medium (in the water) that has a first refractive index which is less than the refractive index of the object 140. Measuring the transmitted wavefront includes obtaining an image of the interference pattern by using the detector 180 and performing image restoration of the transmitted wavefront by using the processor 200. The image restoration of the transmitted wavefront (wavefront restoration) is performed by an FFT (Fast Fourier Transform) method. The wavefront restoration by the FFT method is a method of separating a carrier fringe and aberration from each other by using the nature of the aberration disturbing the carrier fringe of the interference pattern. Specifically, the two-dimensional FFT is performed for the interference pattern to convert it to a frequency map. Subsequently, only neighboring part of the carrier frequency in the frequency map is cut out and a coordinate is converted such that the carrier frequency is located at an origin to perform an iFFT (inverse Fast Fourier Transform). Accordingly, a phase term of a complex amplitude map can be obtained. The phase map obtained as a result is the transmitted wavefront.

Subsequently, at step S12, using the tank interchange mechanism 150, the tank 131 that is filled with the oil (second medium) is inserted into the optical path of the collimator lens 120. The oil (second medium) has a second refractive index that is less than the refractive index of the object 140 and that is different from the first refractive index. The measuring unit measures a transmitted wavefront (second transmitted wavefront) of the object 140 while the reference light 102 enters the object 140 in the second medium (in the oil).

At step S11 and S12, the processor 200 further calculates a transmitted wavefront obtained by the detector 180 for each medium by using a known refractive index distribution. In this case, since the refractive index distribution of the object 140 is not known, a suitable refractive index distribution is assumed or an ideal refractive index distribution such as a state where there is no refractive index distribution (specific refractive index distribution) is assumed to calculate a simulation wavefront Wₛᵢₘ of the transmitted wavefront. The object that has a known refractive index distribution as described above is also referred to as a reference object. The known refractive index distribution may be any of a designed value or measured value. The simulation wavefront Wₛᵢₘ can also be referred to as a transmitted wavefront corresponding to the reference object. The simulation wavefront Wₛᵢₘ at a point (x,y) in the reference object is represented as the following expression (3).

Wₛᵢₘ_{_{—}}_{water}(x,y)=OPₛᵢₘ_{_{—}}_{water}(x,y)−OPₛᵢₘ_{_{—}}_{water}(0,0)

Wₛᵢₘ_{_{—}}ₒᵢₗ(x,y)=OPₛᵢₘ_{_{—}}ₒᵢₗ(x,y)−OPₛᵢₘ_{_{—}}ₒᵢₗ(0,0)

OPₛᵢₘ_{_{—}}_{water}(x,y)=L1(x,y)+L2(x,y)N_{water}+L3(x,y)Ng+L4(x,y)N_{water}+L5(x,y)

OPₛᵢₘ_{_{—}}ₒᵢₗ(x,y)=L1(x,y)+L2(x,y)Nₒᵢₗ+L3(x,y)Ng+L4(x,y)Nₒᵢₗ+L5(x,y) (3)

FIGS. 3A and 3B are diagrams of describing a case where the water is used as the first medium. In expression (3), symbols L1 to L5 denote geometric distances between respective elements along the light beam illustrated in FIG. 3B (convergent light 103). The light beam (convergent light 103) schematically represents a light beam that passes through the point (x,y) in the reference object 141 illustrated in FIG. 3A. In expression (3), N_{water} is a refractive index of water, Nₒᵢₗ is a refractive index of oil, and Ng is an ideal refractive index of the object 140 (refractive index of the reference object 141). In other words, the reference object 141 is used to replace the refractive index distribution of the object 140 with a known value. In this embodiment, in order to simplify the expression, the thickness of a wall of the tank 130 is not taken into account.

At steps S11 and S12, the processor 200 further calculates a difference wavefront between the measure value of the transmitted wavefront for each medium (each of the first transmitted wavefront and the second transmitted wavefront) and the calculated value of the simulation wavefront for each medium. The measure value of the transmitted wavefront contains (1) a refractive index distribution of the object, (2) influence of an object shape, (3) influence of an error of the object shape, and (4) an offset caused by the measuring system. The simulation wavefront includes (2) the influence of the object shape and (4) the offset caused by the measuring system. Therefore, calculating the difference between them, the processor 200 is capable of calculating (1) the refractive index distribution of the object and (3) the influence of the error of the object shape that are residues as waveform aberrations W_{water} and Wₒᵢₗ.

This will be described by using expressions in more detail. The transmitted wavefronts measured at steps S11 and S12 are represented as the following expression (4), similarly to the simulation wavefront in expression (3).

$${W}_{m\_water} ( x , y ) = {OP}_{m\_water} ( x , y ) - {OP}_{m\_water} ( 0 , 0 ) \\ {W}_{m\_oil} ( x , y ) = {OP}_{m\_oil} ( x , y ) - {OP}_{m\_oil} ( 0 , 0 ) \\ {OP}_{m\_water} ( x , y ) = L 1 ( x , y ) + L 2 ( x , y ) {N}_{water} + \{ L 3 ( x , y ) + d L \} {N}_{2 D} ( x , y ) + \{ L 4 ( x , y ) - d L \} {N}_{water} + L 5 ( x , y ) \\ {OP}_{m\_oil} ( x , y ) = L 1 ( x , y ) + L 2 ( x , y ) {N}_{oil} + \{ L 3 ( x , y ) + d L \} {N}_{2 D} ( x , y ) + \{ L 4 ( x , y ) - d L \} {N}_{oil} + L 5 ( x , y ) \qquad ( 4 )$$

In expression (4), symbol N_{2D}(x,y) denotes a refractive-index distribution projection value (first refractive-index distribution projection value) that is averaged in an optical path direction of the object 140 at the coordinate (x,y). Symbol dL denotes a thickness error of the object 140 at the coordinate (x,y). The difference between the measured value of the transmitted wavefront and the simulation wavefront is represented as the following expression (5). In this embodiment, in order to simplify the expression, it is assumed that the refractive index Ng is equal to a center refractive index N(0,0) of the object 140.

$$\begin{matrix}{W}_{water} = {W}_{m\_water} - {W}_{sim\_water} \\ = L 3 ( x , y ) \{ {N}_{2 D} ( x , y ) - Ng \} + dL ( x , y ) \{ {N}_{2 D} ( x , y ) - {N}_{water} \} - \\ dL ( 0 , 0 ) \{ Ng - {N}_{water} \}\end{matrix} \\ \begin{matrix}{W}_{oil} = {W}_{m\_oil} - {W}_{sim\_oil} \\ = L 3 ( x , y ) \{ {N}_{2 D} ( x , y ) - Ng \} + dL ( x , y ) \{ {N}_{2 D} ( x , y ) - {N}_{oil} \} - \\ dL ( 0 , 0 ) \{ Ng - {N}_{oil} \}\end{matrix} \qquad ( 5 )$$

Subsequently, at step S13, the processor 200 removes the shape component of the object 140 from the difference wavefront of each medium calculated at steps S11 and S12 to calculate the refractive-index distribution projection value (first refractive-index distribution projection value) in a radial direction. Specifically, using the following expression (6), the processor 200 removes a shape component dL of the object 140 based on the wavefront aberration W_{water} and the wavefront aberration Wₒᵢₗ to calculate the refractive-index distribution projection value N_{2D}(x,y). In this embodiment, an approximate expression represented by the following expression (7) is used.

$$\begin{matrix}{N}_{2 D} ( x , y ) = Ng + \frac{1}{L 3 ( x , y )} \times \frac{( Ng - {N}_{water} ) {W}_{oil} - ( Ng - {N}_{oil} ) {W}_{water}}{{N}_{oil} - {N}_{water}} & ( 6 ) \\ \{ {N}_{2 D} ( x , y ) - Ng \} dL ( x , y ) \approx 0 & ( 7 )\end{matrix}$$

As described above, the processor 200 can obtain the first refractive-index distribution projection value of the object 140 (refractive-index distribution projection value N_{2D} (x,y) in the radial direction for the object 140) based on measurement results of the first transmitted wavefront and the second transmitted wavefront.

Next, steps S14 and S15 will be described. At step S14, first, an object 142 (reference object) is prepared. Preferably, the object 142 has the same shape and refractive index distribution as those of the object 140. The object 142 may use the object 140 by itself. Subsequently, the prepared object 142 is cut in a flat surface that is parallel to a first direction. Preferably, the first direction is a direction that is parallel to the optical axis OA measured at step S11 and S12. Preferably, the first direction is a direction in which part of light of the reference light 102 travels. Preferably, the object 142 is cut in two flat surfaces that are parallel to the optical axis OA measured at steps S11 and S12 (fabricated in a slice shape). Preferably, the two flat surfaces are substantially parallel to each other. In this embodiment, the object 142 that is cut in these two flat surfaces is referred to as a slice-shaped object 142.

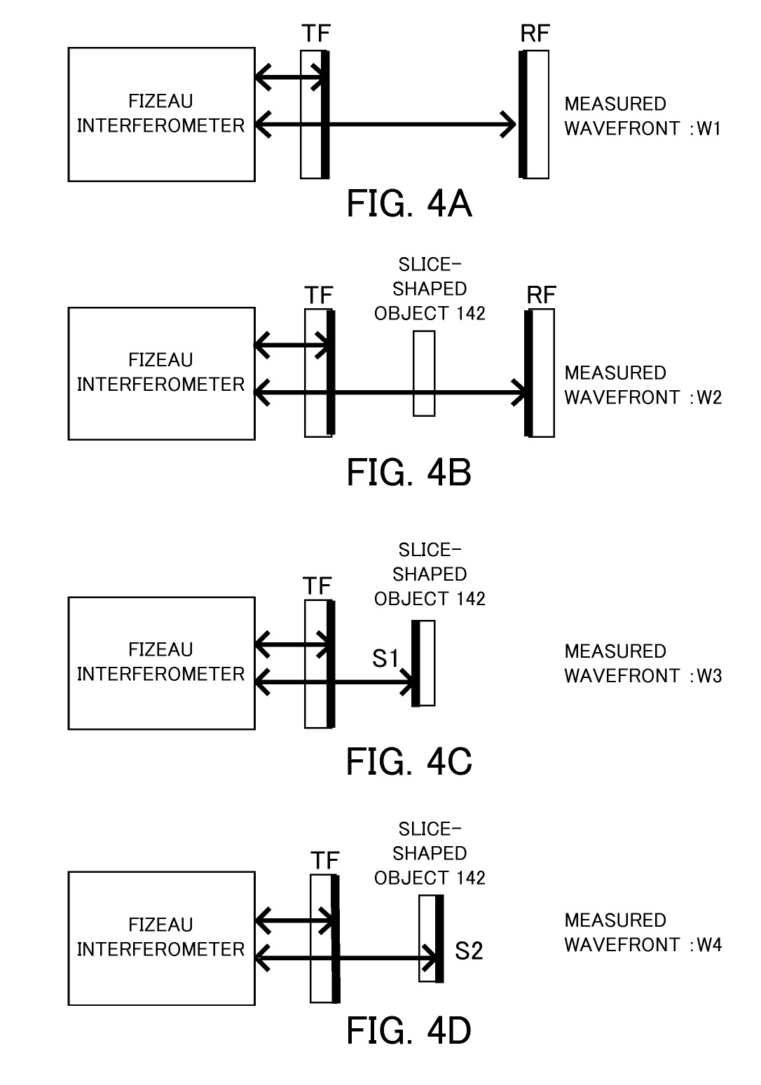

Next, referring to FIGS. 4A to 4D, for the refractive-index distribution measuring apparatus 10, the configuration to achieve step S15 of FIG. 1 will be described. FIGS. 4A to 4D are configuration diagrams of the refractive-index distribution measuring apparatus 10 (apparatus that measures the refractive index distribution of the slice surface). FIGS. 4A to 4D illustrate states in which four types of measured wavefronts W1, W2, W3, and W4 are obtained by using a Fizeau interferometer.

First, in FIG. 4A, using the Fizeau interferometer, the difference between a reference glass TF and a reference mirror RF is obtained as a measured wavefront W1. Subsequently, in FIG. 4B, the difference between a transmitted wavefront (third transmitted wavefront) of the slice-shaped object 142 (reference object) and the reference mirror RF, and the reference glass TF is obtained as a measured wavefront W2. In FIG. 4C, the difference between a front surface shape S1 of the slice-shaped object 142 and the reference glass TF is obtained as a measured wavefront W3. Then, in FIG. 4D, the difference between a rear surface shape S2 of the slice-shaped object 142 and the reference glass TF is obtained as a measured wavefront W4. The measured wavefronts W1, W2, W3, and W4 are represented as the following expression (8).

W1=RF−TF

W2=RF−TF+N_{slice}(y,z)D+(Ng−1)(S2−S1)

W3=S1−TF

W4=NgS2−(Ng−1)S1−TF (8)

In expression (8), symbol N_{slice}(y,z) denotes a refractive index on a slice surface of the slice-shaped object 142 (second refractive-index distribution projection value). Symbol z denotes an optical axis direction, and symbol y denotes a direction perpendicular to the optical axis. Symbol D denotes a thickness of the slice-shaped object 142 at the slice surface side. In order to simplify the expression, a constant thickness D and a reference refractive index Ng as a constant value are used in expression (8). To be exact, these values have distributions instead of constants, but the result of N_{slice}(y,z) does not substantially change even when these values are approximated by constants.

Using expression (8), the refractive index distribution on the slice surface of the slice-shaped object 142 (second refractive-index distribution projection value) is calculated as the following expression (9).

$${N}_{slice} ( y , z ) = Ng + \frac{Ng ( W 2 - W 1 ) + ( Ng - 1 ) ( W 3 - W 4 )}{NgD} \qquad ( 9 )$$

When the shape of the object 142 is extremely different from that of the object 140, the refractive index distribution on the slice surface is enlarged or reduced in the plane (y,z) or is cut out to process data related to the refractive index distribution to have the same sized data as those of the object 140.

As described above, the refractive index distribution N_{slice}(y, z) of the slice surface of the slice-shaped object 142 can be obtained. In other words, in this embodiment, the transmitted wavefront (third transmitted wavefront) of the object 142 is measured while the reference light (second light) enters the slice-shaped object 142 in a second direction that is different from a first direction (for example, the optical axis direction). Preferably, the second direction is a direction perpendicular to the cut surface of the cut object 142, i.e. a direction perpendicular to the optical axis. Then, the second refractive-index distribution projection value of the object 142 (refractive index distribution N_{slice}(y,z)) is calculated based on the measurement result of the third transmitted wavefront.

In this embodiment, the method of performing the measurements four times as illustrated in FIGS. 4A to 4D is described as a measuring method to achieve step S15, but the embodiment is not limited to this. For example, in FIGS. 4A to 4D, an interferometer which scans a wavelength of the light source of the Fizeau interferometer to perform a measurement of stepping a phase can also be used. In this case, performing a Fourier transform for a plurality of measured data that are obtained by performing wavelength scanning for each measurement point and then resolving the transformed data for each frequency, each frequency component indicates the measured wavefronts W2, W3, and W4. Therefore, the measured wavefronts W2, W3, and W4 of expression (8) can be obtained by one wavelength scanning measurement. Furthermore, fabricating the shape of the slice surface to be sufficiently flat, the measurement of the measured wavefronts W3 and W4 can be omitted (do not have to be measured).

Subsequently, at step S16, the processor 200 creates a weighting function based on the refractive-index distribution projection value that is calculated at step S13. The weighting function is obtained to increase the weighting of part where the difference between the refractive-index distribution projection value and a real three-dimensional refractive index distribution is large to determine an important part (important information) of the information (prior information) calculated at step S15. Accordingly, the weighting function is not limited to a function, and a physical quantity that represents a distribution of the weighting (information related to the weighting) may be used. For example, the weighting function is a function that depends on both the refractive-index distribution projection value and an amount of change of the refractive-index distribution projection value (a gradient of the refractive-index distribution projection value). This is because the three-dimensional refractive index is greatly changed in the part where the refractive index of the refractive-index distribution projection value is high or is greatly changed and therefore the difference between the refractive-index distribution projection value and the three-dimensional refractive index distribution increases.

The weighting function w(r) is for example represented as the following expression (10).

$$\{ \begin{matrix}r = \sqrt{{x}^{2} + {y}^{2}} \\ w ( r ) = \frac{1}{2} [ \frac{{N}_{2 D}}{max ( {N}_{2 D} ) - min ( {N}_{2 D} )} + \frac{\frac{\partial {N}_{2 D}}{\partial r}}{max ( \frac{\partial {N}_{2 D}}{\partial r} ) - min ( \frac{\partial {N}_{2 D}}{\partial r} )} ]\end{matrix} \qquad ( 10 )$$

The weighting function is not limited to the function represented as expression (10), and may be a function which simply depends only on a magnitude of the refractive-index distribution projection value. The weighting function may be a function which depends only on the amount of change of the refractive-index distribution (the gradient of the refractive-index distribution projection value). The order of steps S14 and S15 may be changed with any orders of steps S11 to S13 and S16. For example, steps S14 and S15 may be performed prior to steps S11 to S13.

Subsequently, at step S17, the processor 200 determines a refractive index distribution in a depth direction. Then, at step S18, the processor 200 calculates a three-dimensional refractive index distribution. First, the three-dimensional refractive index distribution that is to be calculated is represented as the following expression (11).

N_{3D}(x,y,\vec{L}(x,y)) (11)

(\vec{L}: vector L)

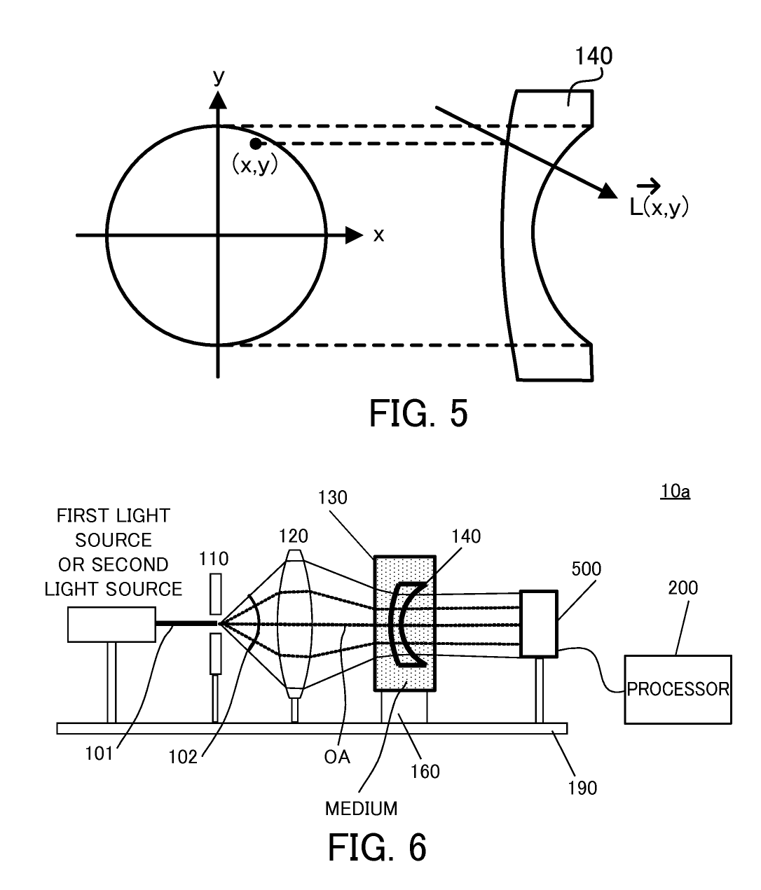

For symbol (x, y, vector L(x,y)) in expression (11), vector L (x,y) denotes an averaged direction of the light beams of the two media that pass through a certain point (x,y) in the object illustrated in FIG. 5.

Next, a three-dimensional refractive index distribution N_{3D} that is to be obtained and the refractive-index distribution projection value N_{2D} are represented by the relation of the following expression (12).

$${N}_{2 D} ( x , y ) = \frac{\int {N}_{3 D} ( x , y , \vec{L} ( x , y ) ) d \vec{L}}{\int d \vec{L}} \qquad ( 12 )$$

When both satisfy expression (12) and the three-dimensional refractive index distribution N_{3D} is averaged along the optical path that is measured at step S11 and S12 (first step), the refractive-index distribution projection value N_{2D} in the radial direction can be obtained.

Subsequently, the refractive index distribution N_{slice}(y,z) on the slice surface can be represented as the following expression (13).

N_{slice}(x,y,\vec{L}(x,y)) (13)

The refractive index distribution in the depth direction that is determined at step S17 is represented as the following expression (14). Expression (14) means that the depth direction is a transmission direction of light at the time of measurement, and defines a distribution where an integral value in the depth direction is small or zero.

$$w ( x , y ) ( {N}_{slice} ( x , y , \vec{L} ( x , y ) ) - \frac{\int {N}_{slice} ( x , y , \vec{L} ( x , y ) ) d \vec{L}}{\int d \vec{L}} ) \qquad ( 14 )$$

The three-dimensional refractive index distribution that is calculated at step S18 is represented as the following expression (15).

$${N}_{3 D} ( x , y , \vec{L} ( x , y ) ) = {N}_{2 D} ( x , y ) + w ( x , y ) ( {N}_{slice} ( x , y , \vec{L} ( x , y ) ) - \frac{\int {N}_{slice} ( x , y , \vec{L} ( x , y ) ) d \vec{L}}{\int d \vec{L}} ) \qquad ( 15 )$$

The refractive-index distribution projection value (first refractive-index distribution projection value) in the radial direction calculated at step S13 can be measured without cutting the object 140. However, obtainable information is a two-dimensional refractive-index distribution projection value. On the other hand, the refractive index distribution on the slice surface (second refractive-index distribution projection value) is not highly-accurate refractive index distribution because the refractive index distribution may be changed by the stress release at the time of cutting the object 142. Therefore, when the refractive-index distribution projection value (first refractive-index distribution projection value) and the refractive index distribution on the slice surface (second refractive-index distribution projection value) are combined at step S18, the refractive index distribution in the depth direction that is represented by expression (14) is defined. Accordingly, highly-accurate three-dimensional refractive index distribution can be obtained.

Since the refractive index distribution is changed by the stress release at the timing of cutting the object or the like, the refractive index distribution N_{slice} is different from the three-dimensional refractive index distribution N_{3D} that is to be obtained. The refractive index distribution is much changed by the stress release for the component that is generated in the radial direction of the object 142. The refractive index distribution N_{slice} and the three-dimensional refractive index distribution N_{3D} are related to the following expression (16) where Δ(x,y) is the component in the radial direction in the change of the refractive index distribution generated at the time of cutting the object and δ(x, y, vector L) is its residual.

N_{slice}(x,y,\vec{L}(x,y))=N_{3D}(x,y,\vec{L}(x,y))+Δ(x,y)+δ(x,y,\vec{L}(x,y)) (16)

The right side of expression (15) can be represented as the following expression (17) by using expression (16).

$${wN}_{3 D} + ( 1 - w ) {N}_{2 D} + w ( δ - \frac{\int δ d \vec{L}}{\int d \vec{L}} ) \qquad ( 17 )$$

As described above, defining the refractive index distribution in the depth direction as expression (14), the three-dimensional refractive index distribution that is not affected by the radial component Δ of the change of the refractive index distribution can be obtained.

At step S16, the weighting is set so that the weighting function is greater for the part where the difference between the refractive-index distribution projection value and the three-dimensional refractive index distribution. With respect to this part, the refractive index distribution in the depth direction is weighed heavily to have the three-dimensional distribution, and thus the difference between the refractive-index distribution projection value and the three-dimensional refractive index distribution can be reduced. On the other hand, for apart where the difference between the refractive-index distribution projection value and the three-dimensional refractive index distribution is small, the weighting is set so that the weighting function is smaller. With respect to this part, decreasing the weighting, the influence of the error contained in the refractive index distribution in the depth direction can be reduced. As a result, highly-accurate three-dimensional refractive index distribution can be obtained. According to expression (17), the residual δ is evaluated to be sufficiently small, the weighting function w may be set to 1. Thus, obtaining the refractive index distribution related to the depth in the transmission direction of the light, the highly-accurate three-dimensional refractive index distribution can be obtained.

As described above, the refractive-index distribution measuring method in this embodiment includes the step (steps S11 and S12) of measuring the transmitted wavefront of the object and the step (step S13) of determining the first refractive index distribution of the object based on the measurement result of the transmitted wavefront. The method in this embodiment further includes the step (step S17) of determining the third refractive index distribution in the transmission direction of the light of the transmitted wavefront based on the information related to the second refractive index distribution of the object. The method in this embodiment further includes the step (step S18) of calculating the three-dimensional refractive index distribution of the object based on the first refractive index distribution and the third refractive index distribution. The refractive-index distribution measuring apparatus in this embodiment includes the measuring unit (detector 180) configured to measure the transmitted wavefront of the object and the processing unit (processor 200) configured to calculate the three-dimensional refractive index distribution of the object.

Preferably, the refractive-index distribution measuring method in this embodiment further includes the step (step S16) of obtaining the weighting function based on the first refractive index distribution, and the three-dimensional refractive index distribution is calculated by using the weighting function. More preferably, the weighting function is a function that depends on at least one of the first refractive index distribution and the amount of change of the first refractive index distribution (the gradient of the first refractive-index distribution). Preferably, the third refractive index distribution is a distribution in which the integral value in the transmission direction of the light (depth direction) is zero. Preferably, the information related to the second refractive index distribution is the measured value of the refractive index distribution based on the transmitted wavefront of the light that transmits through the cut surface of the reference object.

Preferably, the step of measuring the transmitted wavefront of the object includes the step (step S11) of measuring the first transmitted wavefront of the object while the light enters the object in the first medium (for example, water) that has the first refractive index less than the refractive index of the object. This step further includes the step (step S12) of measuring the second transmitted wavefront of the object while the light enters the object in the second medium (for example, oil) that has the second refractive index which is less than the refractive index of the object and is different from the first refractive index. This step further includes the step (step S13) of removing the shape component of the object based on the measurement results of the first transmitted wavefront and the second transmitted wavefront.

More preferably, in this embodiment, the first transmitted wavefront of the object is measured while the reference light enters the object in the water that has the first refractive index less than the refractive index of the object. In addition, the second transmitted wavefront of the object is measured while the reference light enters the object in the oil that has the second refractive index which is less the refractive index of the object and is different from the refractive index of the water. Furthermore, the transmitted wavefront obtained when the reference object that has a specific refractive index distribution is located at a measurement position in each of the water and the oil is calculated. The difference between the measured first and second transmitted wavefronts and the difference between the calculated first and second transmitted wavefronts are obtained. Then, the refractive-index distribution projection value in the radial direction of the object is obtained based on the difference between the first and second transmitted wavefronts. Furthermore, slicing the reference object that has the same shape and refractive index distribution as those of the object and measuring the transmitted wavefront in a direction perpendicular to the slice surface, the refractive index distribution of the slice surface is obtained. In addition, extracting the refractive index distribution in the transmission direction of the light at the time of measurement based on the refractive index distribution of the slice surface and multiplying the extracted refractive index distribution by the weighting function determined based on the refractive-index distribution projection value, the refractive index distribution in the depth direction is obtained. Furthermore, adding the refractive index distribution in the depth direction to the refractive-index distribution projection value, the three-dimensional refractive index distribution is obtained. As a result, even when the object has a high refractive index, the three-dimensional refractive index distribution of the object can be exactly measured.

In this embodiment, the case where the Talbot interferometer is used, and other shearing interferometer such as a lateral shearing interferometer and a radial shearing interferometer can also be used. In this embodiment, the water and the oil is used as media, but the embodiment is not limited to these media and the air or various kinds of oils may be combined as two media. As can be seen from the flow or the expressions in this embodiment, the refractive index distribution can be obtained regardless of rotational symmetry or rotational asymmetry. This embodiment uses the assumption that the shape of the object has rotational symmetry for easy explanation, but the embodiment can also be applied to an object which has rotational asymmetry.

According to this embodiment, the refractive-index distribution measuring method and the refractive-index distribution measuring apparatus capable of measuring the three-dimensional refractive index distribution of the object with high accuracy can be provided even when the object has a high refractive index.

### Embodiment 2

Next, a refractive-index distribution measuring method and a refractive-index distribution measuring apparatus in Embodiment 2 of the present invention will be described. This embodiment describes a case where two types of light sources are used to measure a refractive index distribution. Embodiment 1 performs the measurements of the transmitted wavefront twice by using the two types of media, while this embodiment performs a plurality of measurements of the transmitted wavefront (twice) by using two types of wavelengths of light sources (light having a first wavelength and light having a second wavelength).

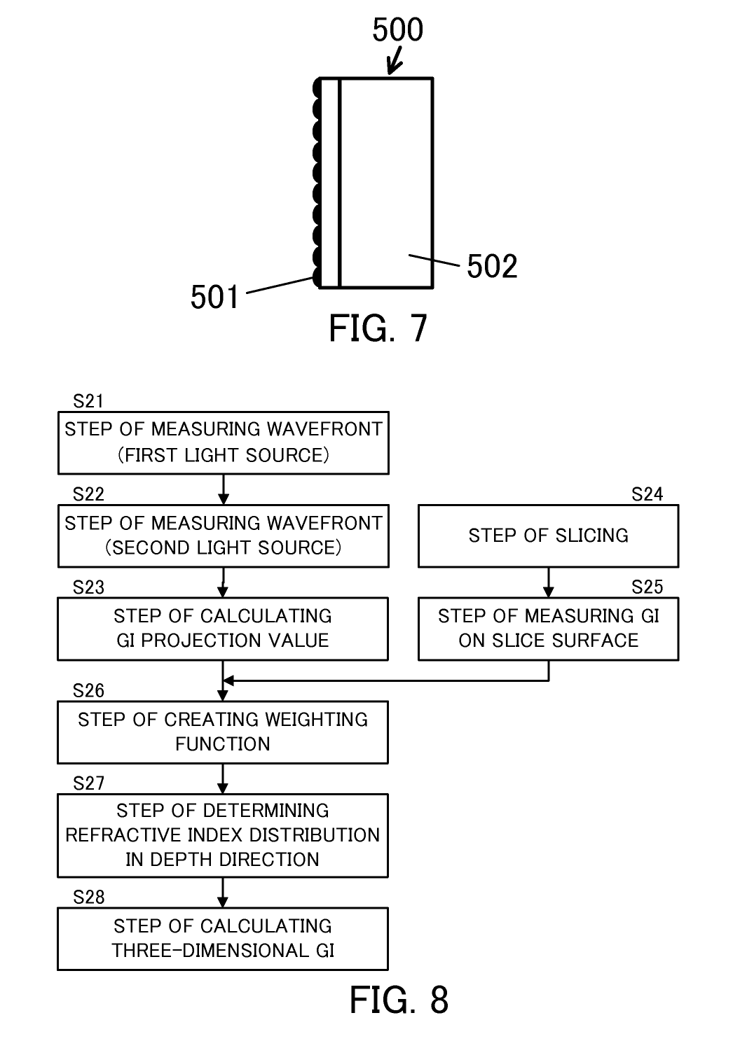

Referring to FIG. 6, the configuration of a refractive-index distribution measuring apparatus in this embodiment will be described. FIG. 6 is a configuration diagram of a refractive-index distribution measuring apparatus 10a. In this embodiment, a He—Ne laser (633 nm) is used as a first light source, and a double harmonic wave (532 nm) of a YAG laser is used as a second light source. A medium around the object 140, which will be described below, may be a medium that has a refractive index less than that of the object 140 and that is higher than that of air. The medium may be water or oil that has a low refractive index around 1.5 to 1.8. A pinhole 110 generates light (reference light) that has an ideal spherical wave by using a laser beam emitted from the first light source or the second light source. Similarly to FIG. 2, this light passes through the object 140 and its transmitted wavefront is measured by a Shack-Hartmann sensor 500 (measuring unit) as a wavefront measuring sensor. As illustrated in FIG. 7, the Shack-Hartmann sensor 500 includes a lens array 501 and a CCD 502.

Similarly to Embodiment 1, the collimater lens 120, the tank 130, and the Shack-Hartmann sensor 500 are disposed on a rail (not illustrated) that is arranged in parallel to the optical axis OA. Moving these components on the rail, the light beam entering the object 140 can be changed to any of a divergent light, a parallel light, and a convergent light. As a result, the numerical aperture NA of the light beam that enters the Shack-Hartmann sensor 500 can be adjusted.

The Shack-Hartmann sensor 500 needs to strictly control the numerical aperture NA of the incident light beam compared to the Talbot interferometer. However, since it is not necessary to align the diffraction grating 170 and the detector 180 with the Talbot distance when the Shack-Hartmann sensor 500 is used, the positioning of the sensor can be easily performed. The Shack-Hartmann sensor 500 has a structure in which the light entering the lens array 501 is collected onto the CCD 502. When an inclined transmitted wavefront enters the lens array 501, a position of a light collecting point is shifted. The Shack-Hartmann sensor 500 is capable of converting the inclination of the transmitted wavefront to the position shift of the light collecting point, and therefore it is possible to measure a wavefront with a large amount of aberration.

Subsequently, referring to FIG. 8, the refractive-index distribution measuring method in this embodiment will be described. FIG. 8 is a flowchart of illustrating the refractive-index distribution measuring method. The refractive-index distribution measuring method in this embodiment is different from that in Embodiment 1 in that steps S11 and S12 of FIG. 1 are changed to steps S21 and S22. According to this, steps S13 to S18 that are performed for each medium that is used to the measurements at steps S11 and S12 of FIG. 1 are changed to steps S23 to S28 that are performed for each light source that is used to the measurements at steps S21 and S22, respectively. However, since steps S23 to S28 are basically the same as steps S13 to S18 of FIG. 1 respectively, common descriptions are omitted.

At step S21, first, the first light source is inserted and the positioning of the Shack-Hartmann sensor 500 with respect to the object 140 is performed. Then, the light (light having the first wavelength) emitted from the first light source enters the pinhole 110 to measure a transmitted wavefront W_{A}. Subsequently, at step S22, using the second light beam that has different wavelength from that of the first light source, the light (light having the second wavelength) emitted from the second light source enters the pinhole 110 to measure a transmitted wavefront W_{B}. In other words, in this embodiment, the transmitted wavefront W_{A} (first transmitted wavefront) of the object 140 is measured while the light having the first wavelength (first reference light) enters the object 140 in a medium that has a refractive index different from that of the object 140. Furthermore, the transmitted wavefront W_{B} (second transmitted wavefront) of the object 140 is measured while the light having the second wavelength (second reference light) that is different from the first wavelength enters the object 140 in the same medium.

Then, as described in Embodiment 1, the refractive-index distribution measuring apparatus 10a performs steps S23 to S28 (corresponding to steps S13 to S18 in Embodiment 1). As a result, a three-dimensional refractive index distribution can be calculated. At steps S21 and S22 in this embodiment, a difference wavefronts (transmitted wavefronts W_{A} and W_{B}) can be obtained as represented by the following expression (18).

$${W}_{A} = L 3 ( x , y ) \{ {Nave}_{HeNe} ( x , y ) - {Ng}_{HeNe} \} + dL ( x , y ) \{ {Nave}_{HeNe} ( x , y ) - {N}_{oil\_HeNe} \} - dL ( 0 , 0 ) \{ {Ng}_{HeNe} - {N}_{oil\_HeNe} \} \\ {W}_{B} = L 3 ( x , y ) \{ {Nave}_{YAG} ( x , y ) - {Ng}_{YAG} \} + dL ( x , y ) \{ {Nave}_{YAG} ( x , y ) - {N}_{oil\_YAG} \} - dL ( 0 , 0 ) \{ {Ng}_{YAG} - {N}_{oil\_YAG} \} \qquad ( 18 )$$

In expression (18), symbols Nave_{HeNe}(x,y) and Nave_{YAG}(x,y) are refractive-index distribution projection values at a position (x,y) in the object 140 for the first light source (He—Ne laser) and the second light source (YAG double harmonic wave), respectively. Symbols Ng_{HeNe} and Ng_{YAG} are ideal refractive indices (refractive indices of the reference object) of the object 140 for each of the respective light sources. Symbols Nₒᵢₗ_{_{—}}_{HeNe} and Nₒᵢₗ_{_{—}}_{YAG} are refractive indices of the medium for the respective light sources.

The refractive indices for the first light source and the second light source are related by the following expression (19).

$${Nave}_{YAG} ( x , y ) = \frac{{Ng}_{YAG} - 1}{{Ng}_{HeNe} - 1} {Nave}_{HeNe} ( x , y ) \qquad ( 19 )$$

At step S23, the refractive-index distribution projection value represented by the following expression (20) is obtained.

$${Nave}_{HeNe} ( x , y ) = {Ng}_{HeNe} + \frac{1}{L 3 ( x , y )} \times \frac{( {Ng}_{HeNe} - {N}_{oil\_HeNe} ) {W}_{B} - ( {Ng}_{YAG} - {N}_{oil\_YAG} ) {W}_{A}}{\frac{{Ng}_{YAG} - 1}{{Ng}_{HeNe} - 1} ( {Ng}_{HeNe} - {N}_{oil\_HeNe} ) - ( {Ng}_{YAG} - {N}_{oil\_YAG} )} \qquad ( 20 )$$

The measuring unit in this embodiment only needs to be able to measure an amount corresponding to a quantity corresponding to a gradient of the wavefront shape of the transmitted wavefront or an inclination of the light beam and be able to detect a physical quantity that can measure the gradient or the inclination even when the transmitted wavefront has a large amount of aberration. Therefore, this embodiment is not limited to the Shack-Hartmann method, and a measuring unit using a Hartmann method or Ronchi test may be adopted.

In this embodiment, preferably, the step of measuring the transmitted wavefront of the object includes the step (step S21) of measuring the first transmitted wavefront of the object while the light having the first wavelength enters the object. Furthermore, the step includes the step (step S22) of measuring the second transmitted wavefront of the object while the light having the second wavelength that is different from the first wavelength enters the object in this medium. The step of determining the first refractive index distribution of the object includes the step (step S23) of removing the shape component of the object based on the measurement results of the first transmitted wavefront and the second transmitted wavefront.

According to this embodiment, a refractive-index distribution measuring method and a refractive-index distribution measuring apparatus that are capable of measuring a three-dimensional refractive index distribution of an object with high accuracy can be provided even when the object has a high refractive index.

### Embodiment 3

Next, a refractive-index distribution measuring method and a refractive-index distribution measuring apparatus in Embodiment 3 of the present invention will be described. In this embodiment, the shape of the object 140 has been known or measured, and a method of calculating a refractive index distribution in a depth direction by using a predicted value of the refractive index distribution as prior information without using a weighting function will be described.

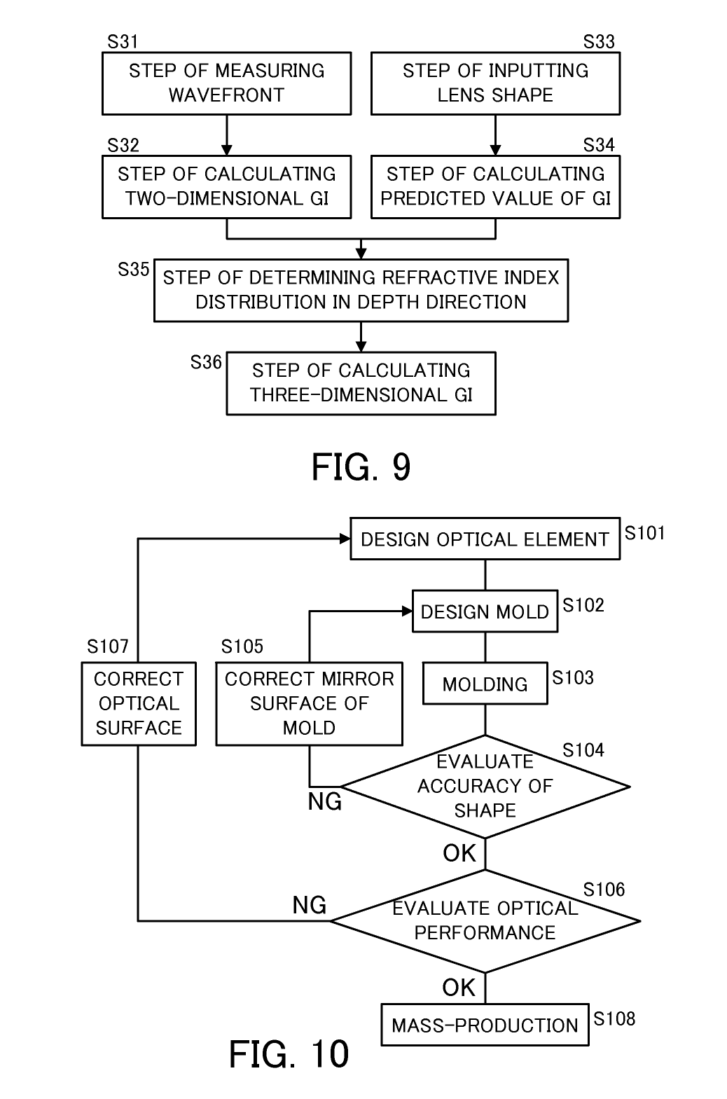

Referring to FIG. 9, the refractive-index distribution measuring method in this embodiment will be described. FIG. 9 is a flowchart of illustrating the refractive-index distribution measuring method. First, at step S31, a measuring unit and a processor 200 measures and obtains a wavefront aberration of the object 140. Specifically, similarly to Embodiment 1, the measuring unit measures a transmitted wavefront of the object 140. Subsequently, the processor 200 calculates a transmitted wavefront in a case where a reference object 141 that has the same shape as that of the object 140 and that has a known refractive index distribution is located at the same position as that of the object 140. The difference between the two transmitted wavefronts is the wavefront aberration of the object 140. In this embodiment, the shape and the thickness of the object 140 have been known or measured. When the shapes or the thicknesses of the object 140 and the reference object 141 are extremely different from each other, the processor 200 corrects (calibrates), by calculation, the wavefront that changes depending on the difference of the shapes or the thicknesses. Subsequently, at step S32, the processor 200 divides the wavefront aberration obtained at step S31 by a thickness distribution of the object 140. As a result, a two-dimensional refractive index distribution, i.e. a refractive-index distribution projection value can be calculated.

At steps S33 and S34, the processor 200 calculates the predicted value of the refractive index distribution based on a lens shape (shape information of the object 140). In this embodiment, the calculated predicted value of the refractive index distribution is called prior information. At step S33, the shape information of the object 140 is input.

Subsequently, at step S34, the processor 200 obtains the predicted value of the refractive index distribution based on the input lens shape.

In this embodiment, C1 denotes a curvature that is obtained by performing a spherical approximation for a first surface of the lens shape, C2 denotes a curvature that is obtained by performing the spherical approximation for a second surface of the lens shape, and D denotes a thickness distribution. In this case, a predicted value N_{p3D} of the refractive index distribution is, for example, represented by the following expression (21).

$${N}_{p 3 D} ( r , z ) = Ng + a ( \frac{{D}_{0}}{D ( r )} - 1 ) + b ( C 1 - C 2 ) ( \frac{D ( {r}_{max} )}{D ( r )} - 1 ) z \qquad ( 21 )$$

The refractive index distribution (predicted value of the refractive index distribution) represented by expression (21) is assumed to have a rotationally symmetric distribution. In expression (21), symbol r denotes a radial direction and symbol z denotes an optical axis direction. Symbol D₀ denotes a center thickness of the object 140, and symbol rₘₐₓ denotes a radius of an end of the object. Symbols a and b are constants, and are determined based on an empirical value of the refractive index distribution of a sample that has a similar shape or molding condition. Thus, the value obtained by using the refractive-index distribution function depending on the thickness distribution or the curvature of the object 140 is the predicted value of the refractive index distribution. The predicted value of the refractive index distribution is not limited to expression (21), and for example it can also be represented as the following expression (22) or (23).

$$\begin{matrix}{N}_{p 3 D} ( r , z ) = Ng + \frac{a}{D ( r )} + b ( C 1 - C 2 ) z + c ( C 1 - C 2 ) {z}^{2} + d ( C 1 - C 2 ) {z}^{3} & ( 22 ) \\ {N}_{p 3 D} ( r , z ) = Ng + a exp ( - \frac{D ( r ) - {D}_{0}}{{D}_{0}} ) - a + b ( C 1 - C 2 ) ( \frac{D ( {r}_{max} )}{D ( r )} - 1 ) z & ( 23 )\end{matrix}$$

Subsequently, at step S35, the processor 200 defines the refractive index distribution N_{p3D} in the depth direction according to the following expression (24). In expression (24), the vector L indicates the transmission direction of the light at the time of measurement.

$${N}_{p 3 D} ( r , \vec{L} ( r ) ) - \frac{\int {N}_{p 3 D} ( r , \vec{L} ( r ) ) d \vec{L}}{\int d \vec{L}} \qquad ( 24 )$$

Subsequently, at step S36, as represented by the following expression (25), the processor 200 adds the refractive-index distribution projection value N_{2D} to the refractive index distribution N_{p3D} in the depth direction to obtain the three-dimensional refractive index distribution.

$${N}_{3 D} ( r ) = {N}_{2 D} ( r ) + {N}_{p 3 D} ( r , \vec{L} ( r ) ) - \frac{\int {N}_{p 3 D} ( r , \vec{L} ( r ) ) d \vec{L}}{\int d \vec{L}} \qquad ( 25 )$$

In this embodiment, the information related to the second refractive index distribution is a refractive-index distribution function based on the shape of the object (lens shape). The third refractive index distribution in the transmission direction (depth direction) of the light of the transmitted wavefront is determined based on the information related to this second refractive index distribution.

According to this embodiment, a refractive-index distribution measuring method and a refractive-index distribution measuring apparatus that are capable of measuring a three-dimensional refractive index distribution of an object with high accuracy can be provided even when the object has a high refractive index.

### Embodiment 4

Next, Embodiment 4 of the present invention will be described. The refractive-index distribution measuring method (measurement result of the refractive index distribution) described in each embodiment (each of Embodiments 1 to 3) can also be fed back to a method of manufacturing an optical element such as a lens.

Referring to FIG. 10, a method of manufacturing an optical element using mold forming will be described. FIG. 10 is a flowchart of illustrating the method of manufacturing the optical element in this embodiment.

In FIG. 10, first at step S101, the optical element is designed. For example, a designer designs the optical element by using optical design software or the like. Then, at step S102, a mold is designed and fabricated to perform the mold forming of the optical element based on the optical element designed at step S101. Subsequently, at step S103, the optical element is molded by using the mold designed and fabricated at step S102.

Subsequently, at step S104, the shape of the optical element molded at step S103 is measured and the accuracy (accuracy of the shape) is evaluated. When the accuracy of the shape evaluated at step S104 does not satisfy a required accuracy (NG), a correction amount of a mirror surface of the mold is calculated at step S105. Then, at step S102, the mold is designed and fabricated again. On the other hand, when the accuracy of the shape evaluated at step S104 satisfies the required accuracy (OK), the optical performance of the optical element is evaluated at step S106.

At step S106, the refractive index distribution of the optical element (object 140) is measured by using the refractive-index distribution measuring method described in each embodiment (each of Embodiments 1 to 3), and the optical performance of the optical element is evaluated. Applying the refractive-index distribution measuring method described in each embodiment to step S106 (step of evaluating the optical performance), it is possible to mass-produce optical elements made of a glass material with a high refractive index. When the optical performance evaluated at step S106 does not satisfy a required specification, a correction amount of an optical surface is calculated at step S107. Then, at step S101, the optical element is designed by using the correction amount calculated at step S107. On the other hand, when the optical performance evaluated at step S106 has a desired optical performance (i.e. the optical performance satisfies the required specification), the optical elements are mass-produced at step S108.

According to this embodiment, a refractive index distribution in the optical element can be measured with high accuracy. Therefore, a method of manufacturing the optical element in which the optical element using a glass material with a high refractive index is mass-produced by mold forming with high accuracy can be provided.

### Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC) IC)) for performing the functions of one or more of the above-described embodiment (s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to readout and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-051270, filed on Mar. 14, 2014, which is hereby incorporated by reference wherein in its entirety.

1. A refractive-index distribution measuring method comprising the steps of:
measuring a transmitted wavefront of an object;
determining a first refractive index distribution of the object based on a measurement result of the transmitted wavefront;
determining a third refractive index distribution in a transmission direction of light of the transmitted wavefront based on information related to a second refractive index distribution of the object; and
calculating a three-dimensional refractive index distribution of the object based on the first refractive index distribution and the third refractive index distribution.

2. The refractive-index distribution measuring method according to claim 1, further comprising the step of obtaining a weighting function based on the first refractive index distribution, wherein the three-dimensional refractive index distribution is calculated by using the weighting function.

3. The refractive-index distribution measuring method according to claim 2, wherein the weighting function is a function that depends on at least one of the first refractive index distribution and an amount of change of the first refractive index distribution.

4. The refractive-index distribution measuring method according to claim 1, wherein the third refractive index distribution is a distribution in which an integral value in the transmission direction of the light is zero.

5. The refractive-index distribution measuring method according to claim 1,
wherein the information related to the second refractive index distribution is a measured value of a refractive index distribution based on a transmitted wavefront of light that transmits through a cut surface of a reference object.

6. The refractive-index distribution measuring method according to claim 1,
wherein the step of measuring the transmitted wavefront of the objet includes the steps of:
measuring a first transmitted wavefront of the object while light enters the object in a first medium that has a first refractive index which is less than the refractive index of the object, and
measuring a second transmitted wavefront of the object while the light enters the object in a second medium that has a second refractive index which is less than the refractive index of the object and is different from the first refractive index, and
wherein the step of determining the first refractive index distribution of the object includes the step of removing a shape component of the object based on measurement results of the first transmitted wavefront and the second transmitted wavefront.

7. The refractive-index distribution measuring method according to claim 1,
wherein the step of measuring the transmitted wavefront of the object includes the steps of:
measuring a first transmitted wavefront of the object while light having a first wavelength enters the object in a medium that has a refractive index which is different from the refractive index of the object, and
measuring a second transmitted wavefront of the object while light having a second wavelength which is different from the first wavelength enters the object in the medium, and
wherein the step of determining the first refractive index distribution of the object includes the step of removing a shape component of the object based on measurement results of the first transmitted wavefront and the second transmitted wavefront.

8. The refractive-index distribution measuring method according to claim 1, wherein the first refractive index distribution is a refractive-index distribution projection value in a radial direction of the object.

9. The refractive-index distribution measuring method according to claim 1,
wherein the information related to the second refractive index distribution is a refractive-index distribution function based on a shape of the object.

10. A refractive-index distribution measuring apparatus comprising:
a measuring unit configured to measure a transmitted wavefront of an object; and
a processing unit configured to calculate a three-dimensional refractive index distribution of the object,
wherein the processing unit is configured to:
determine a first refractive index distribution of the object based on a measurement result of the transmitted wavefront by the measuring unit,
determining a third refractive index distribution in a transmission direction of light of the transmitted wavefront based on information related to a second refractive index distribution of the object, and
calculating the three-dimensional refractive index distribution of the object based on the first refractive index distribution and the third refractive index distribution.

11. The refractive-index distribution measuring apparatus according to claim 10, wherein the measuring unit includes a shearing interferometer or a Shack-Hartmann sensor.

12. A method of manufacturing an optical element, the method comprising the steps of:
molding the optical element; and
measuring a refractive index distribution of the optical element as the object by using the refractive-index distribution measuring method to evaluate the optical element, the measuring method comprising the steps of:
measuring a transmitted wavefront of an object;
determining a first refractive index distribution of the object based on a measurement result of the transmitted wavefront;
determining a third refractive index distribution in a transmission direction of light of the transmitted wavefront based on information related to a second refractive index distribution of the object; and
calculating a three-dimensional refractive index distribution of the obiect based on the first refractive index distribution and the third refractive index distribution.

13. A non-transitory computer-readable storage medium which stores a program causing a computer to execute a process comprising the steps of:
measuring a transmitted wavefront of an object;
determining a first refractive index distribution of the object based on a measurement result of the transmitted wavefront;
determining a third refractive index distribution in a transmission direction of light of the transmitted wavefront based on information related to a second refractive index distribution of the object; and
calculating a three-dimensional refractive index distribution of the object based on the first refractive index distribution and the third refractive index distribution.
